(19) United States
(12) Patent Application Publication
(10) Pub. No.: US 2015/0084506 A1
(43) Pub. Date: Mar. 26, 2015

(54) POWER CONTROL METHOD AND SYSTEM OF LAMP

(71) Applicant: Hyundai Motor Company, Seoul (KR)

(72) Inventor: Kang Ho Lee, Incheon (KR)

(73) Assignee: HYUNDAI MOTOR COMPANY, Seoul (KR)

(21) Appl. No.: 14/142,869

(22) Filed: Dec. 29, 2013

(30) Foreign Application Priority Data
Sep. 25, 2013 (KR) 10-2013-0114048

(51) Int. Cl. B60Q 1/14

(52) U.S. Cl. CPC B60Q 1/1415
USPC 315/82

(57) ABSTRACT

A power control method and system of a lamp are provided. The method includes supplying, by a controller, the lamp with electric power and selecting an illumination characteristic data of the lamp changed from a point when the electric power starts to be supplied to the lamp. The duty of voltage supplied to the lamp is variably adjusted, by the controller, based on the illumination characteristic data. In addition, the controller counts a first elapsed time that elapses from a first point when the electric power supplied to the lamp is turned on, and variably adjusts the duty of the voltage supplied to the lamp based on the counted first elapsed time.

### CROSS-REFERENCE TO RELATED APPLICATION

This application claims priority to and the benefit of Korean Patent Application No. 10-2013-0114048 filed in the Korean Intellectual Property Office on Sep. 25, 2013, the entire contents of which are incorporated herein by reference.

### BACKGROUND

(a) Field of the Invention

The present invention is related to a power control method and system of a lamp that maintains substantially uniform illumination of a lamp to improve quality of a vehicle and improve visibility and satisfaction of a driver.

(b) Description of the Related Art

A vehicle headlamp is a lamp used to radiate light in a front direction for a safe driving at night (or other low light conditions). The headlamp enables effect determination of a front side obstacle and radiates light to achieve a predetermined field of view. Additionally, a predetermined level of light is radiated to prevent interfering with the driving of a facing vehicle (e.g., a vehicle traveling in the opposite direction). Accordingly, a method of supplying the headlamp with substantially uniform power is recognized as an important art.

FIG. 5A is an exemplary graph showing luminous intensity based on time of illuminating a lamp according to a related art, and FIG. 5B is an exemplary graph showing voltage based on time that is supplied to a lamp according to the related art. As shown in FIG. 5A, luminous intensity of one of the lamps changes according to time, and the luminous intensity is stabilized after at least 20 minutes or at most 60 minutes. In addition, as shown in FIG. 5B, the voltage supplied to each lamp is substantially uniform. Accordingly, since the luminous intensity of each lamp is changed over time, the product quality, the satisfaction, and the field view of the driver may deteriorate.

The above information disclosed in this section is only for enhancement of understanding of the background of the invention and therefore it may contain information that does not form the prior art that is already known in this country to a person of ordinary skill in the art.

### SUMMARY

The present invention provides a power control method and system of a lamp that may controlling the luminous intensity of a lamp substantially uniformly over time to improve the product quality, the satisfaction, and the field view of a driver.

A power control method of a lamp according to an exemplary embodiment of the present invention may include supplying, by a controller, a lamp with electric power, selecting, by the controller, an illumination characteristic data of the lamp being changed from when the electric power starts to be supplied to the lamp, and variably adjusting, by the controller, the duty of voltage supplied to the lamp based on the illumination characteristic data.

The power control method of a lamp may include counting, by the controller, a first elapse time that elapses from a first point when the electric power supplied to the lamp is turned on, and variably adjusting, by the controller, the duty of the voltage supplied to the lamp based on the counted first elapse time. In addition, the power control method of a lamp may include turning off, by the controller, the electric power supplied to the lamp when the electric power is turned on and the counted first elapsed time is reset to 0, when a second elapsed time that elapses from a second point that is turned off to a third point that is turned on again exceeds (e.g., is greater than) a predetermined value. The power control method of a lamp may include turning off, by the controller, the electric power supplied to the lamp when the electric power is turned on and counting again from the counted first elapsed time at the second point that is turned off, when an elapsed time that elapses from a second point that is turned off to a third point that is turned on again is less than a predetermined value.

The illumination characteristic of the lamp may be an illumination amount characteristic generated from when the electric power is turned on when the voltage supplied to the lamp is substantially uniform. The duty value may be set to a substantially high level when the illumination amount of the lamp is substantially low (e.g., below a predetermined amount), and the duty value is set to a substantially low level when the illumination amount of the lamp is increases to cause the illumination amount of the lamp to be substantially uniform. The duty value may be stored in a pulse width modulation (PWM) duty variable control map table while adjusting the duty.

According to the present invention, the supplied duty value may be controlled based on the luminous intensity characteristic of each lamp, and therefore the luminous intensity of each lamp may be maintained substantially uniformly from an initial turned on condition. Accordingly, the product quality of the vehicle and the filed view of the driver may improve.

### BRIEF DESCRIPTION OF THE DRAWINGS

FIG. 1 is an exemplary schematic diagram of a power control system of a lamp according to an exemplary embodiment of the present invention;

FIG. 2 is an exemplary flowchart showing a power control method of a lamp according to an exemplary embodiment of the present invention;

FIG. 3 is an exemplary graph showing control elements based on time at a power control method of a lamp according to an exemplary embodiment of the present invention;

FIG. 4 is an exemplary graph showing duty values based on time at a power control method of a lamp according to an exemplary embodiment of the present invention;

FIG. 5A is an exemplary graph showing luminous intensity based on time of a lamp according to the related art; and

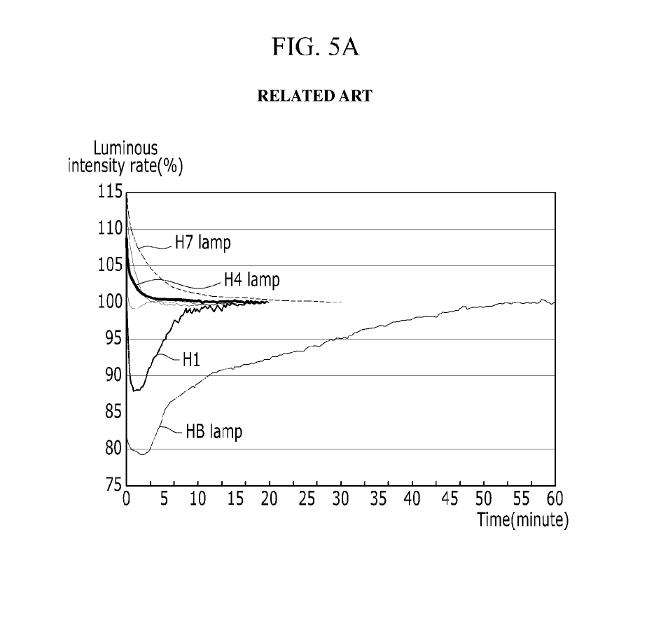

FIG. 5B is an exemplary graph showing voltage based on time supplied to a lamp according to the related.

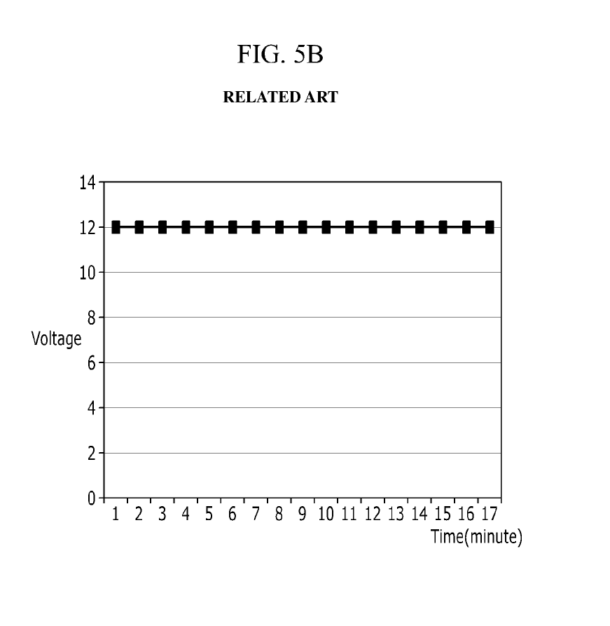

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

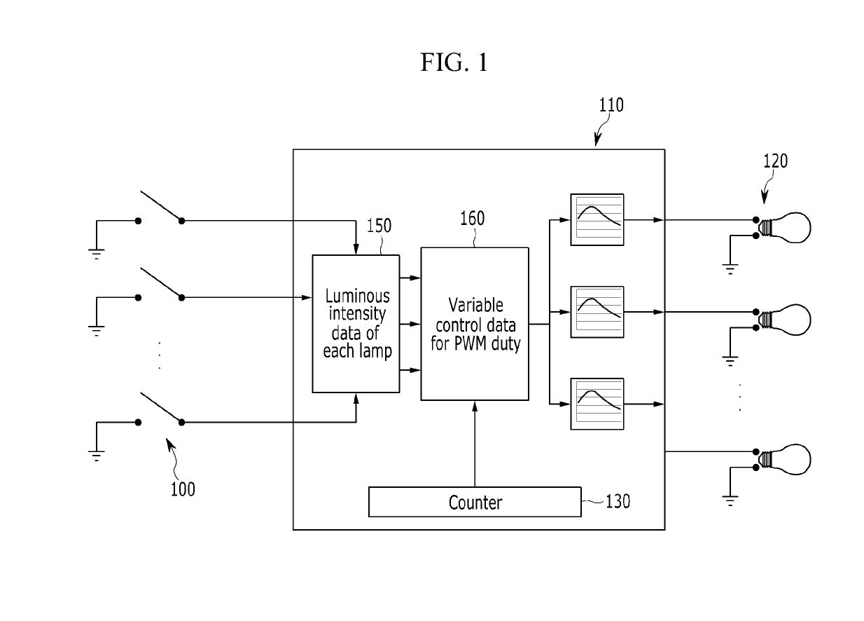

An exemplary embodiment of the present invention will hereinafter be described in detail with reference to the accompanying drawings. FIG. 1 is an exemplary schematic diagram of a power control system of a lamp according to an exemplary embodiment of the present invention. Referring to FIG. 1, a power system of a lamp may include a lamp switch 100, a lamp controller 110, and a lamp 120 and the controller 110 may include a time counter 130, a first memory (memory 1) 150, and a second memory (memory 2) 160. The controller 110 may be configured to operate the lamp switch 100 and the lamp 120.

The lamp switch 100 may be turned off or on by a driver demand or a vehicle controller. In addition, first data (e.g., data 1) for an illumination characteristic of each lamp may be stored in the first memory 150 in a table form, and second data (e.g., data 2) for PWM duty of each lamp based on the first data may be stored in the second memory 1 60 in a table form.

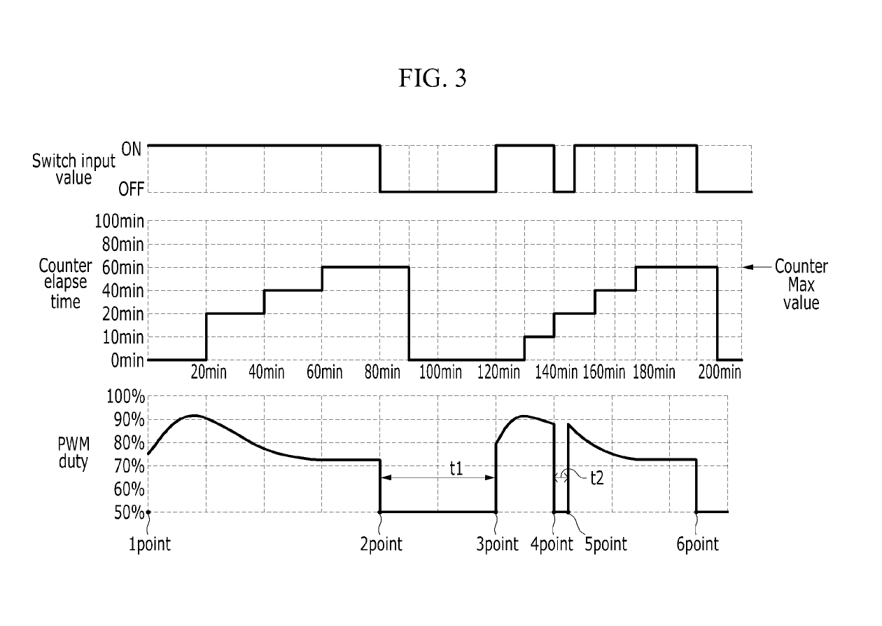

In an exemplary embodiment of the present invention, a counter 130, executed by the controller 110, may be configured to count time (e.g., determine a length of time) from a first point when the switch 100 is turned on, and count time from a second point when the switch 100 is turned off, and count time from a third point when the switch 100 is turned on again. Further, when an elapsed time or a counted time between the second point and the third point is less than a predetermined time, the elapsed time may be counted from the second point. Additionally, when an elapsed time or a counted time between the second point and the third point is greater than a predetermined time, the elapsed time may be reset to 0 and counted from the third point again. Referring to FIG. 3, these time counts will be specifically detailed.

In an exemplary embodiment of the present invention, the voltage supplied to each lamp may be variably adjusted based on the luminous intensity of each lamp, and therefore the luminous intensity of each lamp may be maintained substantially uniformly to improve the field view of the driver and the driving stability.

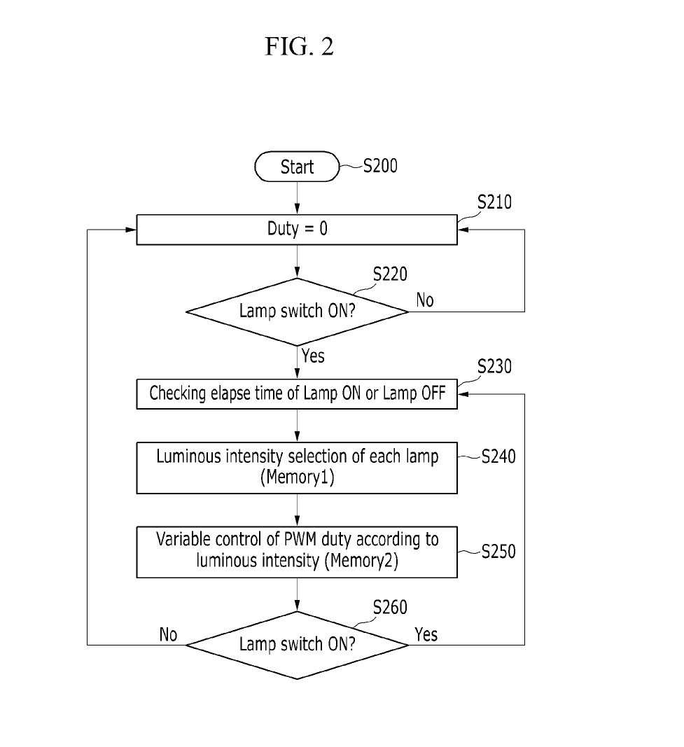

FIG. 2 is an exemplary flowchart showing a power control method of a lamp according to an exemplary embodiment of the present invention. Referring to FIG. 2, a control start may be performed in S200 and the duty may be adjusted to be 0 in S210. In addition, the method may include determining whether a lamp switch 100 is turned on in S220, and when the lamp switch 100 is not turned on, the process may return to S210, and when the lamp switch 100 is turned on, S230 may be performed. A lamp on point and a lamp off point may be detected and an elapsed time may be detected in S230.

Furthermore, a characteristic based on a luminous intensity of each lamp 120 may be selected from the first memory 150 in S240, a PWM duty based on the luminous intensity characteristic may be selected from the second memory 160 in S250, and electric power supplied to each lamp 120 may be variably adjusted. In addition, whether the lamp switch 100 is turned on may be determined in S260. When the lamp switch 100 is turned on, S230 may be performed and when the lamp switch 100 is turned off, S210 may be performed.

FIG. 3 is an exemplary graph showing control elements based on time at a power control method of a lamp according to an exemplary embodiment of the present invention. Referring to FIG. 3, a horizontal axis represents time and a vertical axis represents PWM duty, elapsed time of on-time counter, and on/off condition of a switch input value.

As shown in FIG. 3, the switch input value shows ON and OFF, the ON condition may be at a first point, the sequentially OFF condition may be at a second point, the ON condition may be at a third point, the OFF condition may be at a fourth point, the ON condition may be at a fifth point, and the OFF condition may be at a sixth point. In other words, the exemplary graph in FIG. 3 shows various points (first to sixth point) at which the switch input may be either on or off. In addition, the counter may be configured to determine (e.g., count) time when the switch input value is ON, and the maximum value of the time may be 60 minutes.

Although the switch input value is OFF in the second point, the counted elapsed time may be maintained for about 10 minutes. In addition, when the OFF condition of the switch input value exceeds 10 minutes, the counted elapsed time may be reset to 0, and when the switch input value is turned on at a third point, the elapsed time may be counted from 0 again. The elapsed time between the fourth point and the fifth point may be within 10 minutes, the elapsed time of the counter may be counted again from the fifth point based on the fourth point. Further, when the counted elapsed time in an exemplary embodiment of the present invention reaches a maximum value (e.g., about 60 minutes), a PWM duty value may be maintained substantially uniform to maintain the luminous intensity substantially uniform.

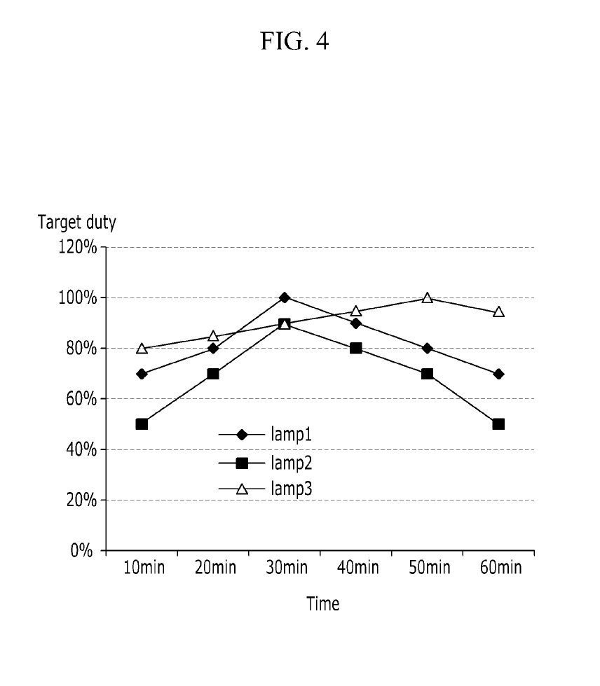

FIG. 4 is an exemplary graph showing duty values based on time at a power control method of a lamp according to an exemplary embodiment of the present invention. Referring to FIG. 4, a horizontal axis represents time and a vertical axis represents a target duty value. As shown, a first lamp (lamp 1), a second lamp (lamp 2), and a third lamp (lamp 3) are provided and the duty value respectively supplied to the first lamp, the second lamp, and the third lamp may be respectively adjusted. Accordingly, the luminous intensity of the first lamp, the second lamp and the third lamp may be adjusted substantially uniformly from an initial turned on condition. Accordingly, a product quality of a vehicle may be improved, and the visibility of a drive may be improved.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

Description of symbols

| | |
|---|---|
| 100: switch | 110: controller |
| 120: lamp | 130: counter |
| 150: memory 1 | 160: memory 2 |

What is claimed is:

1. A power control method of a lamp, comprising:
supplying, by a controller, the lamp with electric power;
selecting, by the controller, an illumination characteristic data of the lamp changed from a point when the electric power starts to be supplied to the lamp; and
variably adjusting, by the controller, a duty of voltage supplied to the lamp based on the illumination characteristic data.

2. The power control method of a lamp of claim 1, comprising:
counting, by the controller, a first elapsed time that elapses from a first point when the electric power supplied to the lamp is turned on; and
variably adjusting, by the controller, the duty of the voltage supplied to the lamp based on the counted first elapsed time.

3. The power control method of a lamp of claim 2, comprising:
turning off, by the controller, the electric power supplied to the lamp when the electric power is turned on and the counted first elapsed time is reset to 0, when a second elapsed time that elapses from a second point when the electric power is turned off to a third point when the electric power is turned on again is greater than a predetermined value.

4. The power control method of a lamp of claim 2, comprising;
turning off, by the controller, the electric power supplied to the lamp when the electric power is turned on and the elapsed time is counted again from the first elapsed time that is counted at the second point when the electric power is turned off, when the elapsed time that elapses from a second point when the electric power is turned off to a third point when the electric power is turned on again is less than a predetermined value.

5. The power control method of a lamp of claim 1, wherein the illumination characteristic of the lamp is an illumination amount characteristic generated from when the electric power is turned on when the voltage supplied to the lamp is substantially uniform.

6. The power control method of a lamp of claim 1, wherein the duty value is increased to a higher level when the illumination amount of the lamp is decreased, and the duty value is decreased to a lower level when the illumination amount of the lamp is increased to maintain a substantially uniform illumination amount of the lamp.

7. The power control method of a lamp of claim 1, wherein the duty value is stored in a pulse width modulation (PWM) duty variable control map table while adjusting the duty.

8. A power control system of a lamp, comprising:
a memory configured to store program instructions; and
a processor configured to execute the program instructions, the program instructions when executed configured to:
supply the lamp with electric power;
select an illumination characteristic data of the lamp changed from a point when the electric power starts to be supplied to the lamp; and
variably adjust a duty of voltage supplied to the lamp based on the illumination characteristic data.

9. The system of claim 8, wherein the program instructions when executed are further configured to:
count a first elapsed time that elapses from a first point when the electric power supplied to the lamp is turned on; and
variably adjust the duty of the voltage supplied to the lamp based on the counted first elapsed time.

10. The system of claim 9, wherein the program instructions when executed are further configured to:
turn off the electric power supplied to the lamp when the electric power is turned on and the counted first elapsed time is reset to 0, when a second elapsed time that elapses from a second point when the electric power is turned off to a third point when the electric power is turned on again is greater than a predetermined value.

11. The system of claim 9, wherein the program instructions when executed are further configured to:
turn off the electric power supplied to the lamp when the electric power is turned on and the elapsed time is counted again from the first elapsed time that is counted at the second point when the electric power is turned off, when the elapsed time that elapses from a second point when the electric power is turned off to a third point when the electric power is turned on again is less than a predetermined value.

12. The system of claim 8, wherein the illumination characteristic of the lamp is an illumination amount characteristic generated from when the electric power is turned on when the voltage supplied to the lamp is substantially uniform.

13. The system of claim 8, wherein the duty value is increased to a higher level when the illumination amount of the lamp is decreased, and the duty value is decreased to a lower level when the illumination amount of the lamp is increased to maintain a substantially uniform illumination amount of the lamp.

14. The system of claim 8, wherein the duty value is stored in a pulse width modulation (PWM) duty variable control map table while adjusting the duty.

15. A non-transitory computer readable medium containing program instructions executed by a controller, the computer readable medium comprising:
program instructions that supply the lamp with electric power;
program instructions that select an illumination characteristic data of the lamp changed from a point when the electric power starts to be supplied to the lamp; and
program instructions that variably adjust a duty of voltage supplied to the lamp based on the illumination characteristic data.

16. The non-transitory computer readable medium of claim 15, further comprising:
program instructions that count a first elapsed time that elapses from a first point when the electric power supplied to the lamp is turned on; and
program instructions that variably adjust the duty of the voltage supplied to the lamp based on the counted first elapsed time.

17. The non-transitory computer readable medium of claim 16, further comprising:
program instructions that turn off the electric power supplied to the lamp when the electric power is turned on and the counted first elapsed time is reset to 0, when a second elapsed time that elapses from a second point when the electric power is turned off to a third point when the electric power is turned on again is greater than a predetermined value.

18. The non-transitory computer readable medium of claim 16, further comprising:
program instructions that turn off the electric power supplied to the lamp when the electric power is turned on and the elapsed time is counted again from the first elapsed time that is counted at the second point when the electric power is turned off, when the elapsed time that elapses from a second point when the electric power is turned off to a third point when the electric power is turned on again is less than a predetermined value.

19. The non-transitory computer readable medium of claim 15, wherein the illumination characteristic of the lamp is an illumination amount characteristic generated from when the electric power is turned on when the voltage supplied to the lamp is substantially uniform.

20. The non-transitory computer readable medium of claim 15, wherein the duty value is increased to a higher level when the illumination amount of the lamp is decreased, and the duty value is decreased to a lower level when the illumination amount of the lamp is increased to maintain a substantially uniform illumination amount of the lamp.
